(19) United States
(12) Patent Application Publication
(10) Pub. No.: US 2008/0040127 A1
(43) Pub. Date: Feb. 14, 2008

(54) Customer Customized Resource Media

(76) Inventors: Carol Jean Williams, Salado, TX (US); Carlos Cantu Garcia, Round Rock, TX (US); Jason Zardiackas, Austin, TX (US)

Correspondence Address: HAMILTON & TERRILE, LLP, P.O. BOX 203518, AUSTIN, TX, 78720, US

(21) Appl. No.: 11/464,224

(22) Filed: Aug. 14, 2006

(51) Int. Cl. G06Q 10/00; G06Q 30/00

(52) U.S. Cl. 705/1

(57) ABSTRACT

A customized resource media creation system for use when configuring a build to order information handling system. More specifically, a customer is provided with an option of creating a customized resource media in place of receiving a preconfigured resource media when configuring an information handling system. The customer is also provided with an option of ordering the standard resource media as well as the customized resource media.

### BACKGROUND OF THE INVENTION

1. Field of the Invention

The present invention relates to information handling system support and more particularly to customer customized resource media.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One issue relevant to information handling systems manufacturers relates to providing resource media to an information handling system customer. The resource media provides software that is used with the information handling systems. The software can include device drivers or patches that are related to application programs that are preloaded onto the information handling system or peripherals that are provided with the information handling system. The resource media may be a resource compact disc (CD) which is shipped with each information handling system. Because device drivers and patches change so frequently, the resource media may be out of date by the time it is shipped with the information handling system.

The issue of providing current resource media is particularly relevant when the ordered information handling system is a build to order information handling system as the resource media may vary along with the configuration of the information handling system. A goal of information handling system manufacturers is to reduce overall customer support costs by enabling customers to support themselves.

Relationship customers (e.g., customers who order large quantities of information handling systems) often manage and deploy multiple generations of information handling systems which are not supported by a current resource media. Additionally, relationship customers often do not want software automatically deployed to their systems without an opportunity to test the software with their information technologies sections.

It would be desirable to provide customers (especially relationship customers) who build to order information handling systems with a customized resource media.

### SUMMARY OF THE INVENTION

In accordance with the present invention, a customized resource media creation system is provided with a build to order information handling system. More specifically, a customer is provided with an option of creating a customized resource media in place of receiving a preconfigured resource media when configuring an information handling system. The customer is also provided with an option of ordering the standard resource media as well as the customized resource media.

More specifically, in one embodiment the invention relates to a system for providing a customized resource media with an information handling system which includes a configurator, a checkout module and a database. The configurator configures the information handling system with options selected according to user input and includes a validator which validates configuration of the information handling system and a resource information module which allows configuration of a customized resource media with software selected by a user during configuration of the information handling system. The checkout module presents payment options and obtains payment and delivery information. The database receives information from and supplies information to the configurator and the checkout module.

In another embodiment, the invention relates to an apparatus for providing a customized resource media with an information handling system includes a configurator, a checkout module and a database. The configurator configures the information handling system with options selected according to user input and includes a validator which validates configuration of the information handling system and a resource information module which allows configuration of a customized resource media with software selected by a user during configuration of the information handling system. The checkout module presents payment options and obtains payment and delivery information. The database receives information from and supplies information to the configurator and the checkout module.

In another embodiment, the invention relates to a method for providing a customized resource media with an information handling system which includes configuring the information handling system with options selected according to user input. The configuring includes validating configuration of the information handling system and allowing configuration of a customized resource media with software selected by a user during configuration of the information handling system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows an overview block diagram representation of an on-line store.

FIG. 2 shows a schematic diagram of a system for installing software.

FIG. 3 shows a schematic block diagram of an information handling system.

FIGS. 4A and 4B, generally referred to as FIG. 4, show a flow chart of the operation of the customized resource media creation system for creating a customized resource media.

### DETAILED DESCRIPTION

An on-line store is one component of an Internet website to which a customer may go to configure a particular information handling system, for example, according to desired options of the customer. The on-line store is typically a subset of a larger Internet website. At the on-line store, a customer can select one or more products in which the customer is interested. Upon selection of a particular product, the on-line store presents the customer with the ability to go to the product information for the particular product, customize the product, price the customized product, purchase the product, and other actions as discussed herein. While shopping happens in the website (i.e., selection of a particular kind of system by a customer), when the customer is ready to purchase a customized system, the customer is then directed to that part of the website which the on-line store application controls.

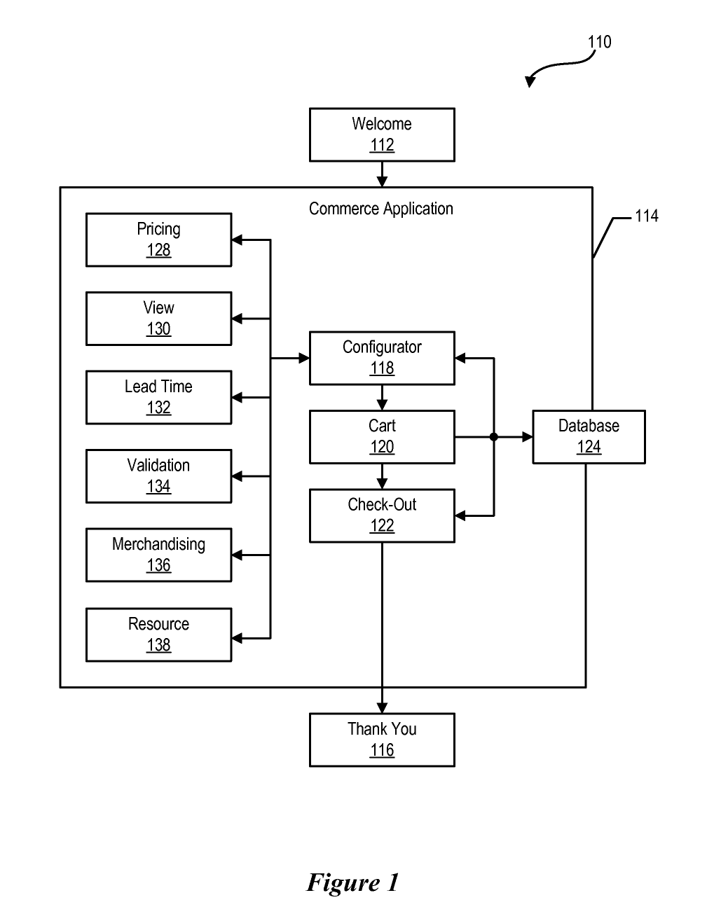

Referring now to FIG. 1, an on-line store 110 for use in generating customer configured information handling systems, e.g., customer configured computer systems, is shown. The on-line store 110 includes a welcome or introductory module 112, a commerce application module 114, and a thank you module 116. The on-line store 110 includes an on-line store user interface which enables the system configuration, pricing, and ordering of an information handling system via the Internet. The commerce application 114 includes a configurator 118, shopping cart 120, a checkout module 122 and database 124. The database 124 provides information to the configurator 118, shopping cart 120, checkout module 122. The configurator 118 includes a pricing module 128, a view module 130, a lead time warning module 132, a validation (or compatibility) warning module 134, a merchandising module 136 and a resource module 138. The various modules of the configurator 118 are driven by data from the database 124, and thus the configurator 118, shopping cart 120, and checkout module 122 are all linked to the database 124.

In operation of the on-line store 110, the welcome module 112 presents a welcome page 112, the configurator 118 presents a configurator page, the shopping cart 120 presents a shopping cart page, the checkout module 122 presents a checkout page, and the thank you module 116 presents a thank you page. The welcome page includes a static page and generally resides outside of the commerce application 114. The configurator page, shopping cart page, and checkout page are within the commerce application and use information provided by the database. The checkout includes a payment feature, delivery feature, personal verses business feature, and instructional text features (i.e., how to fill out an on-line form.)

The welcome page is typically an introductory page and includes a link into the on-line store 110. The welcome page is typically a static welcome page. Upon completion of configuration of a system, the customer is transferred to a checkout page. After completion of the checkout, the customer is transferred to a static thank you page 116. The thank you page 116 provides a message of gratitude to the customer for having placed the order or for visiting the on-line store.

Aspects of the configurator 118 which interact with database 124 are shown in FIG. 1. In essence, the entire commerce application 114 interacts with the database. The configurator 118, shopping cart 120, and checkout module 122 are each part of the commerce application 114 and interact with the database 124. For example, with the shopping cart 120, additional merchandising information associated with a particular system which has been configured and placed in the shopping cart by an on-line store customer can be provided.

The resource module 138 enables a customer to use a customized resource media process. During the configuration process, a customer is provided with an option of creating a customized resource media in place of receiving a preconfigured resource media when configuring an information handling system. The customer is also provided with an option of ordering the preconfigured resource media as well as the customized resource media.

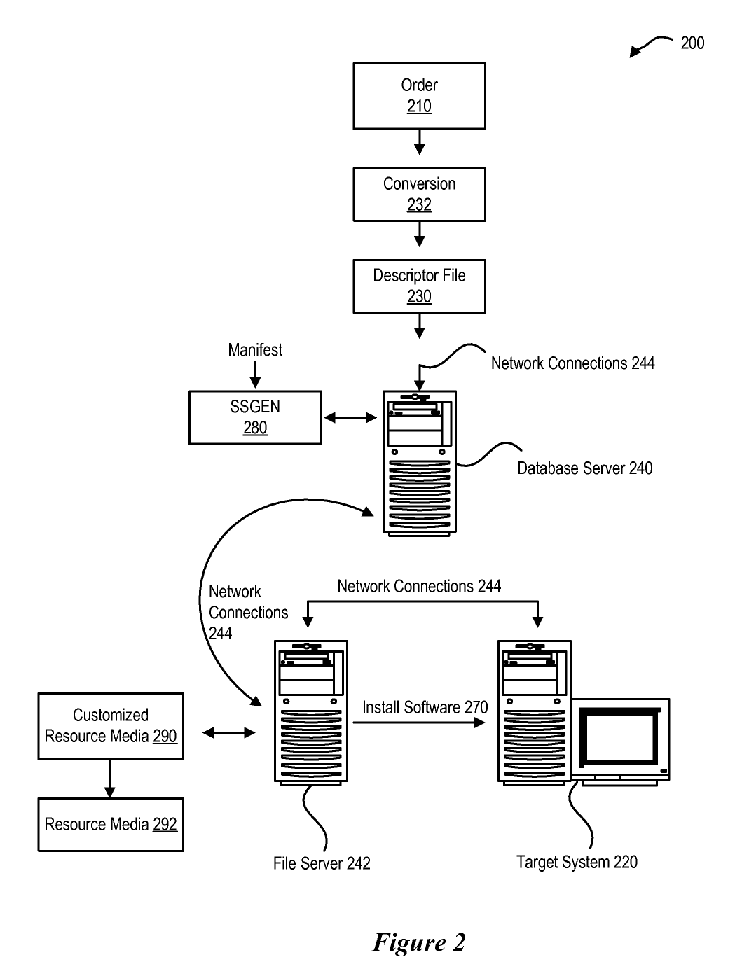

FIG. 2 is a schematic diagram of a software installation system 200 at an information handling system manufacturing site. In operation, an order 210 is placed to purchase a target information handling system 220, via, e.g., the on-line store. The target information handling system 220 to be manufactured contains a plurality of hardware and software components. For instance, target information handling system 220 might include a certain brand of hard drive, a particular type of monitor, a certain brand of processor, as well as particular software products and preordered services. The software may include a particular version of an operating system along with all appropriate driver software and other application software along with appropriate software bug fixes. Before target information handling system 220 is shipped to the customer, the plurality of components are installed and tested. Such software installation and testing advantageously ensures a reliable, working information handling system which is ready to operate when received by a customer.

The installation includes installing components determined to be desirable based upon the ecosystem validation process. The testing includes testing for components that were installed based upon the ecosystem validation process.

Because different families of information handling systems and different individual computer components may require different software installations, it is desirable to determine which software to install on a target information handling system 220. A descriptor file 230 is provided by converting an order 210, which corresponds to a desired information handling system having desired components, into a computer readable format via conversion module 232. The descriptor file 230 includes components component descriptors corresponding to components determined to be desirable based upon the ecosystem validation process.

Component descriptors are computer readable descriptions of the components of target information handling system 220 which components are defined by the order 210. In a preferred embodiment, the component descriptors are included in a descriptor file called a system descriptor record which is a computer readable file containing a listing of the components, both hardware and software, to be installed onto target information handling system 220. Having read the plurality of component descriptors, database server 240 provides an image having a plurality of software components corresponding to the component descriptors to file server 242 over network connection 244. Network connections 244 may be any network connection well-known in the art, such as a local area network, an intranet, or the internet. The information contained in database server 240 is often updated such that the database contains a new factory build environment. The software is then installed on the target information handling system 220 via file server 242. The software is installed on the target information handling system via the image. The image may include self-configuring code.

The database server 240 may also be updated via a software stack generator machine 280. The software stack generator (SSGEN) machine 280 is capable of downloading and installing a configurable set of software parts and then automatically capturing an image of the contents, optionally uploading the image to a shared server such as the database server 240 for later use. The software stack generator machine 280 is capable of being controlled by a centralized front end, thus allowing two or more software stack generator machines to be set up in an image building farm.

In operation, automating the generation of images provides the ability to download the parts to be installed into the image from a network or other storage device. The software stack generator machine 280 may include scriptable package delivery mechanisms. The software stack generator machine 280 may include or receive images which include an integrated rapid install system (IRIS). The integrated rapid install system may then be installed onto the target system when the image is installed onto the target system.

Images to be created are described using a manifest which is represented, e.g., as an XML document. The contents of the image include some or all of a base operating system, application programs, applets (for hardware), etc. The manifest is provided to the software stack generator machine 242 and causes the image building process to begin. After the image is created, the image can be installed onto a target system 220 such that the building of the image is transparent to the target system. For example, the SSGEN machine 280 removes anything from the registry of the operating system that would indicate that the software stack was created by the SSGEN machine 280.

Additionally, the file server 242 may include a customized resource media creation system 290 which creates a customized resource media 292 based upon information provided by the customer during the configuration of the information handling system. Alternately, the information provided by the customer to generate the customized resource media may be obtained after the system is configured.

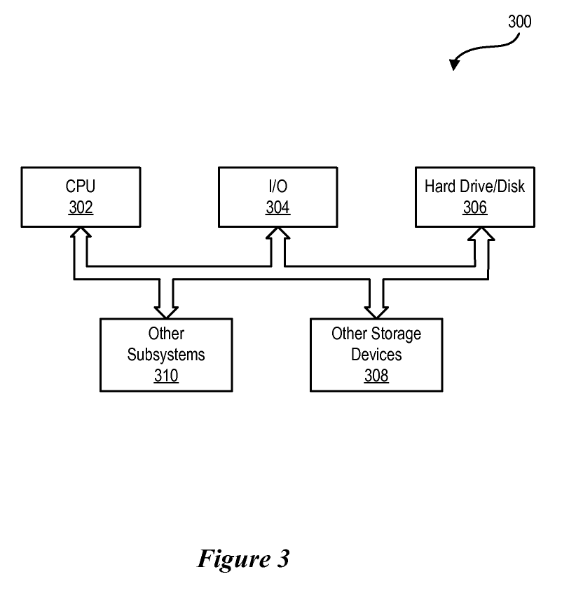

Referring to FIG. 3, a system block diagram of an information handling system 300 such as target information handling system 320 is shown. The information handling system 300 includes a processor 302, input/output (I/O) devices 404, such as a display, a keyboard, a mouse, and associated controllers, memory 306 including non-volatile memory such as a hard disk drive and volatile memory such as random access memory, and other storage devices 308, such as a floppy disk and drive and other memory devices, and various other subsystems 310, all interconnected via one or more buses, shown collectively as bus 312.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

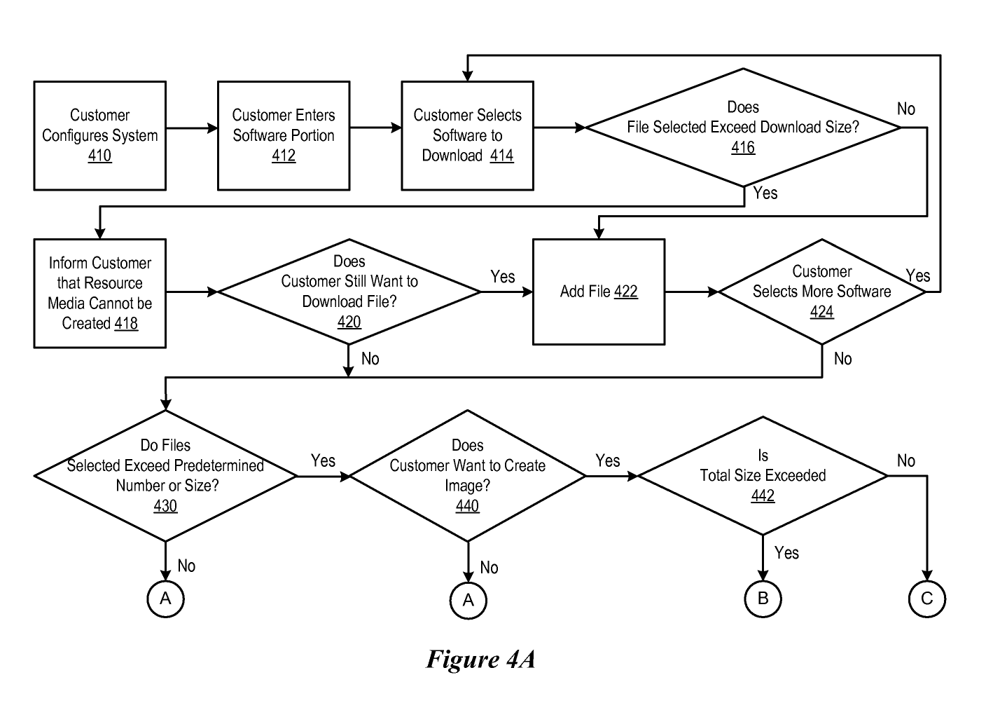

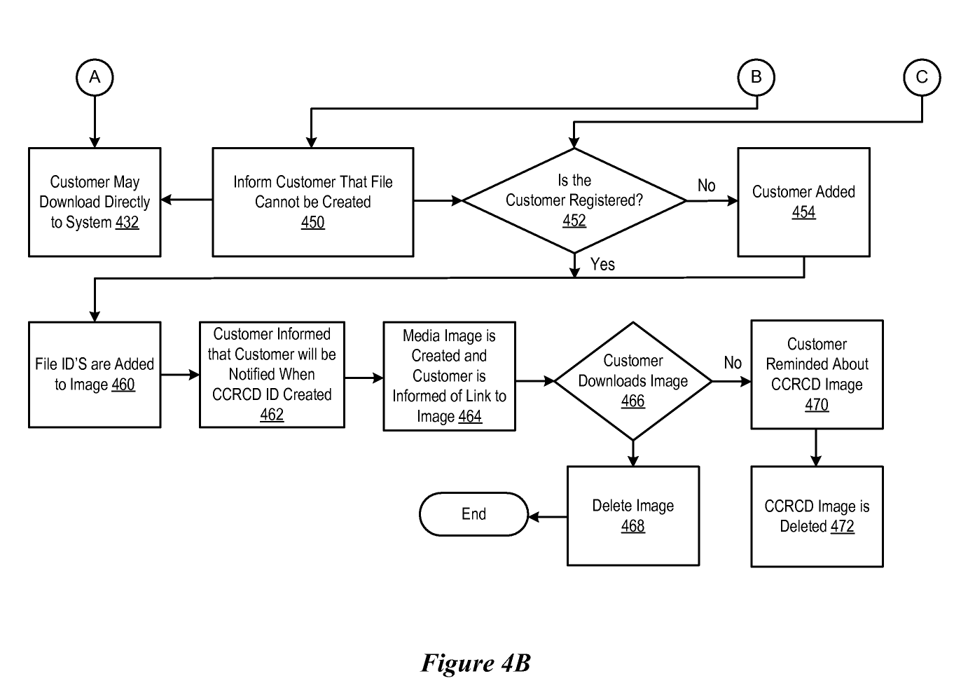

Referring to FIG. 4, a flow chart of the operation of the customized resource media creation system 292 for creating a customized resource media is shown. More specifically, after a customer configures an information handling system via the configurator 118 at step 410, the customer is transferred to a software portion of the configurator 118. While within the software portion of the configurator, the customer may select an operating system to install onto the configured information handling system as well as additional application software to install at step 412. In selected embodiments, this software portion of the configurator may be referred to as a drivers and download section. Next, at step 414, the customer selects driver of software to download and adds a software identifier for the selected software to a download folder for downloading. For example, the selected software may be added to a “My Downloads” folder. Next the total size of the software to be downloaded is checked to determine whether the size of the selected file causes the total size of the software to be downloaded to exceed a predetermined size at step 416. For example, the predetermined size might be 650 MByte, which is the amount of information that can typically be stored on a CD ROM. If the size of all the files for download exceeds the predetermined size, then the customer is informed that a resource media greater than the predetermined size cannot be created and is encouraged to create multiple resource media for the files to be downloaded at step 418. The resource module 138 then determines whether the customer still wishes to download the file at step 420. If so, then the file is added to the download folder at step 422.

If the size of all the files for download does not exceed the predetermined size, then the file is added to the download folder at step 422. The resource module 138 then determines whether the customer wishes to select more software for download at step 424. If so, then the customer selects additional software to download at step 414. If not, then the resource module 138 analyzes the download folder to determine whether a predetermined number of files or a predetermined size of files is exceeded at step 430. For example, the resource module might check to determine whether more than three files are to be downloaded or whether the total size of the files to be downloaded exceeds a certain size (e.g., 50 Mbyte). If the predetermined number of files or predetermined size is not exceeded, then the customer is informed that the files may be downloaded directly to the information handling system at step 432.

If the predetermined number of files or predetermined size is exceeded, then the resource module queries the customer regarding whether the customer desires to create a resource media image at step 440. If not, then the customer is provided the opportunity to download the files directly to the system at step 432. The total size of the files selected to be downloaded is checked to determine whether a predetermined size is exceeded at step 442.

If the total size is exceeded, then the customer is informed that a single resource media cannot be created due to the size of the files to be downloaded at step 450 and the customer is provided with an opportunity to remove files from the download folder or to download the files directly to the system. If the total size is not exceeded, then the resource module 138 determines whether the customer is registered with the customized resource media creation system at step 452 (e.g., by checking the email address of the customer). If the customer is not registered, then the customer is added to the customized resource media creation system at step 454. If the customer is already registered or after the customer is registered, then file identifiers for each of the selected files are added to a resource media image and the resource media is added to a queue to be generated by the customized resource media creation system at step 460. Next, the resource media identifier is provided to the customer along with an estimated creation time for creating the media and an indication that the customer will be notified when the image is crated at step 462. Next, then the image is created and the customer is provided with a link of how to access the image at step 464. When the customer downloads the image at step 466, then the image is deleted from the customized resource media creation system at step 468 and the process completes. If the customer does not download the image, then the customer is sent a reminder after a preset amount of time (e.g., 48 hours) at step 470. If the customer does not download the image after another preset amount of time (e.g., 72 hours), then the image is deleted from the customized resource media creation system at step 472.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs, CD-Rs, or DVDs for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A system for providing a customized resource media with an information handling system comprising:
a configurator, the configurator configuring the information handling system with options selected according to user input, the configurator including
a validator, the validator validating configuration of the information handling system; and,
a resource information module, the resource information module allowing configuration of a customized resource media with software selected by a user during configuration of the information handling system;
a checkout module, the checkout module presenting payment options and obtaining payment and delivery information;
a database, the database receiving information from and supplying information to the configurator and the checkout module.

2. The system of claim 1 wherein:
the software selected by the user includes driver software based upon peripherals to be coupled to the information handling system.

3. The system of claim 1 wherein:
the customized resource media includes at least one of a compact disk (CD) read only memory (CD ROM) media, CD recordable (CD R) media, CD rewritable (CD RW) and digital versatile disc (DVD) media.

4. The system of claim 1 wherein:
the resource media is generated by a customized resource media system.

5. The system of claim 1 wherein:
the user is a relationship customer and the customized resource media is for use with a plurality of configured information handling systems.

6. An apparatus for providing a customized resource media with an information handling system comprising:
a configuration module, the configuration module configuring an information handling system with options selected according to user input, the configurator including
a validation module, the validation module validating configuration of the information handling system; and,
a resource information module, the resource information module allowing configuration of a customized resource media with software selected by a user during configuration of the information handling system;
a checkout module, the checkout module presenting payment options and obtaining payment and delivery information;
a database, the database receiving information from and supplying information to the configurator and the checkout module.

7. The apparatus of claim 6 wherein:
the software selected by the user includes driver software based upon peripherals to be coupled to the information handling system.

8. The apparatus of claim 6 wherein:
the customized resource media includes at least one of a compact disk (CD) read only memory (CD ROM) media, CD recordable (CD R) media, CD rewritable (CD RW) and digital versatile disc (DVD) media.

9. The apparatus of claim 6 wherein:
the resource media is generated by a customized resource media system.

10. The apparatus of claim 6 wherein:
the user is a relationship customer and the customized resource media is for use with a plurality of configured information handling systems.

11. A method for providing a customized resource media with an information handling system comprising:
configuring the information handling system with options selected according to user input, the configuring including
validating configuration of the information handling system; and,
allowing configuration of a customized resource media with software selected by a user during configuration of the information handling system.

12. The method of claim 11 wherein:
the software selected by the user includes driver software based upon peripherals to be coupled to the information handling system.

13. The method of claim 11 wherein:
the customized resource media includes at least one of a compact disk (CD) read only memory (CD ROM) media, CD recordable (CD R) media, CD rewritable (CD RW) and digital versatile disc (DVD) media.

14. The method of claim 11 wherein:
the resource media is generated by a customized resource media system.

15. The method of claim 11 wherein:
the user is a relationship customer and the customized resource media is for use with a plurality of configured information handling systems.
